(19) United States
(12) Patent Application Publication
(10) Pub. No.: US 2014/0282092 A1
(43) Pub. Date: Sep. 18, 2014

(54) CONTEXTUAL INFORMATION INTERFACE ASSOCIATED WITH MEDIA CONTENT

(71) Applicants: Daniel E. Riddell, Oakland, CA (US); Guido Rosso, Palo Alto, CA (US); Fabian Birgfeld, London (GB); Michael Albers, London (GB)

(72) Inventors: Daniel E. Riddell, Oakland, CA (US); Guido Rosso, Palo Alto, CA (US); Fabian Birgfeld, London (GB); Michael Albers, London (GB)

(21) Appl. No.: 13/830,287

(22) Filed: Mar. 14, 2013

(51) Int. Cl. H04L 29/06

(52) U.S. Cl. CPC H04L 65/403
USPC 715/753

(57) ABSTRACT

In embodiments, apparatuses, methods and storage media (transitory and non-transitory) are described that are associated with contextual information interfaces. In various embodiments, a contextual information interface may be presented in association with a media content on a display. In various embodiments, contemporaneously with the presentation of the contextual information interface, information pertinent to the media content and/or a source of the media content may be obtained from a remote computing device. In various embodiments, one or more selectable elements may be selectively rendered, as part of the contextual information interface, based on the obtained information. In various embodiments, the one or more selectable elements may be operable to cause a computing device to present on the display one or more other media contents pertinent to the media content and/or the source of the media content.

### TECHNICAL FIELD

The present disclosure relates to the field of data processing, in particular, to apparatuses, methods and storage media associated with contextual information interfaces associated with media content.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of media content, and the manners in which the content is consumed. Today, myriad media content may be made available from various sources of media content, including but not limited to fixed medium (e.g., Digital Versatile Disk (DVD)), broadcast, cable operators, satellite channels, Internet, and so forth. Users may consume content with a television set, a laptop or desktop computer, a tablet, a smartphone, or other devices of the like. A user wishing to learn more about a particular media content or to consume related media content may utilize more than one of these devices to navigate to a variety of disparate network resources.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an arrangement for content distribution and consumption, in accordance with various embodiments.

FIG. 2 illustrates another arrangement for content distribution and consumption, in accordance with various embodiments.

FIG. 3 illustrates an example player configured with applicable portions of the present disclosure rendering a media content on a display, in accordance with various embodiments.

FIG. 4 illustrates the player of FIG. 3 rendering a contextual information interface overlaying the media content on the display, in accordance with various embodiments.

FIG. 5 depicts an example process that may be implemented on various computing devices described herein, in accordance with various embodiments.

FIG. 6 illustrates an example computing environment suitable for practicing various aspects of the disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an arrangement for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106.

In embodiments, as shown, content aggregator/distributor servers 104 may include encoder 112, storage 114 and content provisioning 116 (referred to as “streaming engine” in FIG. 1), which may be coupled to each other as shown. Encoder 112 may be configured to encode content 102 from various content providers, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device 126. Player 122 may be configured to receive streamed content, decode and recover the content from the content stream, and present the recovered content on display 124, in response to user selections/inputs from user input device 126.

In various embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. In various embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein.

While shown as part of a content consumption device 108, display 124 and/or user input device(s) 126 may be stand-alone devices or integrated, for different embodiments of content consumption devices 108. For example, and as depicted in FIGS. 2-4, for a television arrangement, display 124 may be a stand alone television set, Liquid Crystal Display (LCD), Plasma and the like, while player 122 may be part of a separate set-top set, and user input device 126 may be a separate remote control, gaming controller, keyboard, or another similar device. Similarly, for a desktop computer arrangement, player 122, display 124 and user input device(s) 126 may all be separate stand alone units. On the other hand, for a mobile arrangement, such as a tablet computing device, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for other mobile devices such as a smartphone arrangement, player 122, display 124 and user input device(s) 126 may be likewise integrated.

Referring now to FIG. 2, a player 122 in the form of a set-top box, or “console,” (configured with applicable portions of the present disclosure) may be operably coupled to a display 124, shown here in the form of a flat panel television. In FIG. 2, presentation engine 134 and/or user interface engine 136 of player 122 may render underlying media content 250 on display 124. In various embodiments, media content 250 may be provided to player 122 by content aggregator/distributor server 104. In various embodiments, media content 250 may come from one or more media content sources, such as the one or more providers of content 102 in FIG. 1.

Player 122 may be coupled with various network resources, e.g., via one or more networks 106. These network resources may include but are not limited to content aggregator/distributor servers 104 (described above), one or more social networks 238, one or more entertainment portals 240, and/or one or more commentary portals 242. While each of these network resources is depicted as a single computing device, this is for illustration only, and it should be understood that more than one computing device (e.g., a server farm) may be used to implement each of these network resources. Moreover, one or more of these network resources may be implemented by the same computing device or group of computing devices.

Social network 238 may be a service of which a user 244 may be a member. Social network 238 may track relationships between user 244 and one or more other social network users, which may be referred to as “contacts” or “friends,” Examples of social networks include but are not limited to Facebook®, MySpace®, Twitter®, Google+, Instagram®, and so forth.

Entertainment portal 240 may include one or more databases of information relating to media content, including information about particular media contents (e.g., movies, television shows, sporting events). Entertainment portal 240 may additionally or alternatively include information (e.g., biographical, latest news, demographic, relationships, etc.) about people associated with various media contents, including but not limited to actors/actresses, directors, crew members, sports team members, contestants, newsworthy people, and so forth. Examples of entertainment portals include but are not limited to media content databases such as the Internet Movie Database (IMDB®), sports websites such as ESPN.com or Yahoo® Sports, news websites, celebrity/entertainment websites like the Thirty Mile Zone, or TMZ®, and so forth.

Commentary portal 242 may include commentary about various media contents. Commentary may include but is not limited to critical reviews of various media contents. In some embodiments, commentary portal 242 and entertainment portal 240 may be combined. For example, IMDB® includes information about media content and associated people, as well as at least some critical information, e.g., from users. Examples of commentary portals include RottenTomatoes®, MetaCritic®, and so forth.

In various embodiments, player 122 may be configured to obtain information from these various network resources and present that information to user 244, e.g., as part of a “contextual information database.” in various embodiments, player 122 may obtain information from each network resource in various ways, including the use of application programming interfaces, or “APIs,” that may be provided by each network resource.

FIGS. 3 and 4 demonstrate how a contextual information interface may be presented to a user, in accordance with various embodiments. In FIG. 3, player 122 may be presenting media content 250. In FIG. 4, user interface engine 136 of player 122 may be rendering a contextual information interface 252 to overlay media content 250, e.g., in response to a user command; while media content continues to be presented, and without fully obstructing the underlying media content being presented. For example, a user pressing an “Info” button on user input device 126 while watching a particular television show may cause user interface engine 136 to render contextual information interface 252.

In various embodiments, contextual information interface 252 may include an arrangement of selectable elements 254. In various embodiments, arrangement of selectable elements 254 may be operable, e.g., by user 244 using user input device 126, to cause player 122 to present one or more media contents related to media content 250 and/or a source of media content. In various embodiments, the other media content linked to by the selectable elements may include digital photographs, video clips pertinent to the media content (e.g., cast interviews, bloopers, trailers, “sneak previews,” “making of . . . ,” etc.), other media contents related to media content 250 (e.g., other episodes of a television show, prequels, sequels, media content with overlapping cast or crew, etc.), websites, and so forth. In various embodiments, the other media content may be obtained from a variety of network resources, including but not limited to on-demand video streaming services such as Netflix® or Hulu®, from content aggregator/distributor 104, from network resources 238-242; and so forth.

In some embodiments, arrangement of selectable elements 254 may be disposed along an axis, such as a horizontal axis as is the case in FIG. 4, a vertical axis, or an axis of any other orientation. A user may navigate through arrangement of selectable elements 254, e.g., using user input device 126 (see FIG. 1) in order to select one of the selectable elements. This may be seen in FIG. 4, where arrangement of selectable elements 254 includes an active selectable element 256 and three inactive selectable elements 258. The selectable element that is currently active may be altered, e.g., in response to input received from user input device 126. In this manner, a viewer may navigate through selectable elements.

In various embodiments, a selectable element may be rendered active by emphasizing it over other selectable elements, including but not limited to making it larger and/or more conspicuous than inactive selectable elements. Likewise, a selectable element may be rendered inactive by de-emphasizing it with respect to an active selectable element. For example, inactive selectable elements may be darkened or grayed out, and/or rendered smaller than an active selectable element.

In various embodiments, contemporaneously with presentation of contextual information interface 254, player 122 may obtain, from one or more network resources (e.g., 238-242 in FIG. 2), information pertinent to the media content, a source of the media content and/or the user. In various embodiments, based on the obtained information, player 122 may selectively render one or more selectable elements of arrangement of selectable elements 254 that are operable to cause player 122 to present, on display 124, one or more other media contents pertinent to media content 250 and/or a source of media content 250.

In various embodiments, player 122 may obtain, e.g., from social network 238, social network information related to media content 250 and/or user 244. This information may include information about media content and/or media content sources consumed and/or preferred by a social network contact of user 244. In various embodiments, the media contents represented by the selectable elements of arrangement of selectable elements 254 may be selected based at least in part on the media content 250 and/or media content sources consumed and/or preferred by the social network contact. For instance, if another media content somehow related to media content 250 is also liked or consumed by a social network friend of user 244, then a selectable element may be rendered, e.g., by user interface engine 136, that is operable to cause player 122 to present that other media content. As another example, if user 244 has particular social network contacts with whose opinions user 244 typically agrees (e.g., shared taste in movies or television shows), then media contents consumed by those contacts may be selected, e.g., by user interface engine 136, to be represented in arrangement of selectable elements 254.

In various embodiments, player 122 may obtain, e.g., from content aggregator/distributor servers 104 and/or social network 238, information about a pattern of media consumption by user 244. In various embodiments, one or more other media contents represented by arrangement of selectable elements 254 may be selected, e.g., by user interface engine 136, based at least in part on the pattern of media consumption of user 244. For example, if user 244 often views interviews of people associated with media content, then user interface engine 136 may render arrangement of selectable elements 254 to include selectable elements operable to cause player 122 to present interviews related to media content 250 (e.g., cast/crew interviews). As another example, if user 244 often views trailers of media content, then user interface engine 136 may render arrangement of selectable elements 254 to include selectable elements operable to cause player 122 to present trailers related to media content 250 (e.g., sequels, prequels, other media content sharing cast/crew members, etc.).

In various embodiments, player 122 may obtain and present, in conjunction with arrangement of selectable elements 254, other information pertinent to media content 250. For example, player 122 may obtain for presentation, e.g., from content aggregator/distributor 104 and/or entertainment portal 240, media content information 262 such as a season number, episode number, and/or a synopsis of media content 250. In various embodiments, player 122 may obtain for presentation, e.g., from entertainment portal 240 and/or social network 238, information related to a person or entity associated with the media content. For example, player 122 may obtain and present a message 264 (e.g., a “Tweet” or other social network status update) from a person or entity associated with media content 250.

In various embodiments, player 122 may obtain, e.g., from commentary portal 242 and/or entertainment portal 240, commentary about media content 250, and may present it as part of contextual information interface 252. For instance, in FIG. 4, a commentary excerpt 266, e.g., from a full review, is presented as part of contextual information interface 252. In some embodiments, commentary excerpt 266 may itself be a selectable element that may be operable to cause player 122 obtain, e.g., from commentary portal or an originating website, the full review, e.g., for presentation on display 124.

In various embodiments, player 122 may obtain for presentation, e.g., from social network 238, social network contact consumption information 268 as part of contextual information interface 252. In FIG. 4, for instance, social network contact consumption information 268 includes a number of social network contacts of user 244 who enjoy media content 250.

In various embodiments, arrangement of selectable elements 254 may include a selectable element that is operable to cause player 122 to present an interface (not shown) for purchasing a good or service related to media content 250. For example, a user may select a link to be taken to an online store, where the user may be presented with merchandise relating to media content 250, such as additional media content (e.g., downloads of other episodes), apparel, games, and so forth.

In various embodiments, arrangement of selectable elements 254 may each depict various types and/or formats of graphics. For example, one or more selectable elements may depict still images (e.g., screen shots, promotional images, etc.) and/or video clips (e.g., excerpts, trailers, etc.) of or associated with media content to which the one or more selectable elements correspond. For example, in some embodiments, active selectable element 256 may depict a video clip while inactive selectable elements 258 may depict still images. In other embodiments, all active and inactive selectable elements may depict videos, but active selectable element 256 may be rendered, e.g., by user interface engine 136 of player 122, more largely and/or more conspicuously than inactive selectable elements 258. In some embodiments, user interface engine 136 and/or presentation engine 134 of player 122 may be configured to render sound associated with the video displayed in active selectable element 256, and may be configured to refrain from rendering sound associated with videos displayed in inactive selectable elements 258.

To focus a viewer's attention on contextual information interface 252 while still enabling the viewer to at least partially consume underlying media content 250, in various embodiments, presentation engine 134 and/or user interface engine 136 of player 122 may cause underlying media content 250 to be rendered somewhat less conspicuously. For example, in FIG. 4, underlying media content 250 is blurred, so that a viewer may still at least partially consume media content 250 and also navigate contextual information interface 252.

In various embodiments, arrangement of selectable elements 254 may include selectable elements that represent multiple versions of a single media content. For example, one selectable element may represent a high-definition (HD) version of media content, and another selectable version may represent a standard definition version. As another example, one selectable element may represent a director's cut of media content, another selectable version may represent a theatrical cut, and/or another element may represented an “unrated” version.

In various embodiments, at least some of the selectable elements of arrangement of selectable elements 254 may be rendered, e.g., by user interface engine 136 of player 122, as a group 270. In various embodiments, group 270 may have a size that is proportional to various things, such as a relatedness between a present media content 250 and media contents corresponding to the selectable elements of group 270. For example, a group 270 of selectable elements that represent other episodes in the same season as a selectable element representing current content (e.g., underlying media content 250) may be larger or smaller than another group 270 of selectable elements that represent episodes from a different season, or from a different but related show (e.g., spin-off, created by same entity, has common cast members, etc.).

Referring back to FIG. 2, in various embodiments, player 122 may identify user 244 using facial or other visual recognition. For instance, in various embodiments, an image capture device 274 may be coupled with player 122, and may be configured to provide captured image data to player 122, e.g., as input for facial recognition logic operating on player 122 or elsewhere. In various embodiments, including the one depicted in FIG. 2, image capture device 274 may be separate from player 122, and may take various forms, such as a camera and/or gaming controller configured to translate visually-observed motion from a user into commands operated upon by player 122. Additionally or alternatively, image capture device 274 may be integral with player 122.

FIG. 5 depicts an example process 500 that may be implemented by user interface engine 136 and/or presentation engine 134 of player 122, in accordance with various embodiments. At operation 502, media content 250 may be rendered, e.g., by presentation engine 134 of player 122, on display 124. At block 504, a command to render contextual information interface 252 may be received, e.g., by player 122, from user input device 126. For instance, a viewer may press an “Info” or other button on a remote control (e.g., 126), and the remote control may transmit a signal to player 122 that may cause user interface engine 136 to begin the process of rendering contextual information interface 252.

At operation 506, one or more viewers capable of consuming media content currently presented, e.g., by user interface engine 136 of player 122, may be identified. For example, player 122 may obtain image data from image capture device 274 of FIG. 2, and using facial recognition or other visual identification techniques, identify user 244 captured in the image data.

At operation 508, information pertinent to media content 250 may be obtained, e.g., by player 122, from social network 238. As described previously, this information may include data related to media content consumed or preferred by social network contacts of user 244, data related to people associated with media content (e.g., Tweets from cast/crew), identifies of social network contacts of user 244 who consumed/have opinions about media content 250, and so forth.

At operation 510, information pertinent to media content 250 may be obtained, e.g., by player 122, from entertainment portal 240. This information may include, but is not limited to, information about media content 250, such as trivia, cast/crew identities, shooting locations, user comments, sport team records/schedules, rosters, and so forth. This information may further include, but is not limited to, information about people associated with media content 250, such as cast/crew biographies, athlete statistics (e.g., points per game, salary, college attended, etc.), other media content featuring overlapping cast/crew, and so forth.

At operation 512, information pertinent to media content 250 may be obtained, e.g., by player 122, from commentary portal 240. This information may include, but is not limited to, commentary about media content 250 by professional critics (e.g., associated with regional news outlets), amateur critics, users of commentary portal, and so forth. In some cases, player 122 may obtain only an except of a full critical review, e.g., such as an excerpt that may be found on a website such as rottentomatoes.com.

At operation 514, user interface engine 136 of player 122 may selectively render arrangement of selectable elements 252 that are operable to cause player 122 to present other media content related to media content 250. In various embodiments, this other media content may be selected, e.g., by player 122, based on information it obtained at operations 506-512.

At operation 516, user interface engine 136 of player 122 may selectively render other information related to media content, such as message media content information 262, message 264, commentary excerpt 266 and/or social network contact consumption information 268. At operation 518, user interface engine 136 and/or presentation engine 134 of player 122 may blur media content 250, so that the user's attention is not drawn away from contextual information interface 252.

Referring now to FIG. 6, an example computer suitable for use for various components of FIGS. 1-4 is illustrated in accordance with various embodiments. As shown, computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control, remote control, gaming controller, image capture device, and so forth) and communication interfaces 610 (such as network interface cards, moderns, infrared receivers, radio receivers (e.g., Bluetooth), and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of the programming instructions implementing the operations associated with content consumption device 108, e.g., operations shown in FIG. 500. The various elements may be implemented by assembler instructions supported by processor(s) 602 or high-level languages, such as, for example, C, that can be compiled into such instructions.

The permanent copy of the programming instructions may be placed into permanent storage devices 606 in the factory, or in the field, through, for example, a distribution medium (not shown), such as a compact disc (CD), or through communication interface 610 (from a distribution server (not shown)). That is, one or more distribution media having an implementation of the agent program may be employed to distribute the agent and program various computing devices.

The number, capability and/or capacity of these elements 610-612 may vary, depending on whether computer 600 is used as a content aggregator/distributor server 104 or a content consumption device 108 (e.g., a player 122), as well as whether computer 600 is a stationary computing device, such as a set-top box or desktop computer, or a mobile computing device such as a tablet computing device, laptop computer or smartphone. Their constitutions are otherwise known, and accordingly will not be further described.

FIG. 7 illustrates an example least one computer-readable storage medium 702 having instructions configured to practice all or selected ones of the operations associated with content consumption devices 108, earlier described, in accordance with various embodiments. As illustrated, least one computer-readable storage medium 702 may include a number of programming instructions 704. Programming instructions 704 may be configured to enable a device, e.g., computer 600, in response to execution of the programming instructions, to perform, e.g., various operations of process 500 of FIG. 5, e.g., but not limited to, to the various operations performed to selectively render contextual information interface 252. In alternate embodiments, programming instructions 704 may be disposed on multiple least one computer-readable storage media 702 instead.

Referring back to FIG. 6, for one embodiment, at least one of processors 602 may be packaged together with computational logic 622 configured to practice aspects of process 500 of FIG. 5. For one embodiment, at least one of processors 602 may be packaged together with computational logic 622 configured to practice aspects of process 500 of FIG. 5 to form a System in Package (SiP). For one embodiment, at least one of processors 602 may be integrated on the same die with computational logic 622 configured to practice aspects of process 500 of FIG. 5. For one embodiment, at least one of processors 602 may be packaged together with computational logic 622 configured to practice aspects of process 500 of FIG. 5 to form a System on Chip (SoC). For at least one embodiment, the SoC may be utilized in, e.g., but not limited to, a mobile computing device such as a computing tablet and/or a smartphone.

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

### EXAMPLES

Example 1 includes at least one computer-readable medium comprising instructions that, in response to execution of the instructions by a computing device, enable the computing device to present a contextual information interface associated with a media content on a display, wherein present the contextual information interface comprises: obtain, from a remote computing device contemporaneously with the presentation of the contextual information interface, information pertinent to the media content and/or a source of the media content; and selectively render, based on the obtained information, one or more selectable elements that are operable to cause the computing device to present on the display one or more other media contents pertinent to the media content and/or the source of the media content.

Example 2 includes the at least one computer-readable medium of Example 1, wherein obtain comprises obtain, from a social network, social network information about a user of the computing, device.

Example 3 includes the at least one computer-readable medium of Example 2, wherein the social network information comprises information about media contents and/or media content sources consumed and/or preferred by a social network contact of the user of the computing device.

Example 4 includes the at least one computer-readable medium of Example 3, wherein the one or more other media contents are selected based at least in part on the media contents and/or media content sources consumed and/or preferred by the social network contact.

Example 5 includes the at least one computer-readable medium of any one of Examples 1-4, wherein the one or more other media contents are selected based at least in part on a pattern of media content consumption of a user of the computing device.

Example 6 includes the at least one computer-readable medium of any one of Examples 1-4, wherein the media content is a first piece of media content in a sequence of media contents, and the one or more other media contents comprise a second piece of media content of the sequence.

Example 7 includes the at least one computer-readable medium of any one of Examples 1-4, wherein the one or more other media contents comprise one or more digital photographs and/or video clips pertinent to the media content.

Example 8 includes the at least one computer-readable medium of Example 7, wherein the video clips comprise an interview with a person associated with the media content.

Example 9 includes the at least one computer-readable medium of any one of Examples 1-4, wherein the information pertinent to the media content comprises information about a person or entity associated with the media content.

Example 10 includes the at least one computer-readable medium of any one of Examples 1-4, wherein the information pertinent to the media content comprises commentary about the media content.

Example 11 includes the at least one computer-readable medium of Example 10, wherein the present further comprises selectively render at least a portion of the commentary contemporaneously with the render the one or more selectable elements.

Example 12 includes the at least one computer-readable medium of any one of Examples 1-4, wherein the one or more selectable elements are further operable to cause the computing device to retrieve, front the remote computing device or another remote computing device, for presentation on the display, other information pertinent to the media content.

Example 13 includes the at least one computer-readable medium of Example 12, wherein the other information pertinent to the media content comprises commentary and/or an interface that is operable to purchase a good or service related to the media content.

Example 14 includes the at least one computer-readable medium of any one of Examples 1-4, wherein present the contextual information interface further comprises present the contextual information interface to overlay the media content as the media content is actively presented on the display.

Example 15 includes the at least one computer-readable medium of Example 14, and further includes instructions that, in response to execution of the instructions by the computing device, enable the computing device to blur at least a portion of the media content while the contextual information interface is presented.

Example 16 includes an apparatus comprising: one or more processors;

memory coupled with the one or more processors; and a user interface engine coupled with the one or more processors and configured to present a contextual information interface associated with a media content on a display, wherein present the contextual information interface comprises: obtain, from a remote computing device contemporaneously with the presentation of the contextual information interface, information pertinent to the media content and/or a source of the media content; and selectively render, based on the obtained information, one or more selectable elements that are operable to cause the apparatus to present on the display one or more other media contents pertinent to the media content and/or the source of the media content.

Example 17 includes the apparatus of Example 16, wherein the remote computing device is associated with a social network, and the information pertinent to the media content and/or a source of the media content comprises social network information about a user of the apparatus.

Example 18 includes the apparatus of Example 17, wherein the social network information further comprises information about media contents and/or media content sources consumed and/or preferred by a social network contact of the user of the apparatus.

Example 19 includes the apparatus of Example 18, wherein the user interface engine is to selectively render the one or more other selectable elements based at least in part on the media contents and/or media content sources consumed and/or preferred by the social network contact.

Example 20 includes the apparatus of any one of Examples 16-1.9, wherein the user interface engine is to selectively render the one or more selectable elements based at least in part on a pattern of media content consumption of a user of the apparatus.

Example 21 includes the apparatus of any one of Examples 16-19, wherein the media content is a first piece of media content in a sequence of media contents, and the one or more other media contents comprise a second piece of media content of the sequence.

Example 22 includes the apparatus of any one of Examples 16-19, wherein the one or more other media contents comprise one or more digital photographs and/or video clips pertinent to the media content.

Example 23 includes the apparatus of Example 22, wherein the video clips comprise an interview with a person associated with the media content.

Example 24 includes the apparatus of any one of Examples 16-19, wherein the information pertinent to the media content comprises information about a person or entity associated with the media content.

Example 25 includes the apparatus of any one of Examples 16-19, wherein the information pertinent to the media content comprises commentary about the media content.

Example 26 includes the apparatus of Example 25, wherein the user interface engine is further to selectively render at least a portion of the commentary contemporaneously with the render the one or more selectable elements.

Example 27 includes the apparatus of any one of Examples 16-19, wherein the one or more selectable elements are further operable to cause the apparatus to retrieve, from the remote computing device or another remote computing device, for presentation on the display, other information pertinent to the media content.

Example 28 includes the apparatus of Example 27, wherein the other information pertinent to the media content comprises commentary and/or an interface that is operable to purchase a good or service related to the media content.

Example 29 includes the apparatus of any one of Examples 16-19, wherein the user interface engine is further to present the contextual information interface to overlay the media content as the media content is actively presented on the display.

Example 30 includes the apparatus of Example 29, wherein the user interface engine is further to blur at least a portion of the media content while the contextual information interface is presented.

Example 31 includes A computer-implemented method comprising: displaying, by a computing device, a media content; obtaining, by the computing device from a remote computing device contemporaneously with the displaying, information pertinent to the media content and/or a source of the media content; and selectively rendering, by the computing device on the display based on obtained information, one or more selectable elements that are operable to cause the computing device to present on the display one or more other media contents pertinent to the media content and/or the source of the media content.

Example 32 includes the computer-implemented method of Example 31, wherein the Obtaining comprises obtaining, by the computing device from a social network, social network information about a user of the computing device.

Example 33 includes the computer-implemented method of Example 32, wherein the obtaining comprises obtaining, by the computing device from the social network, information about media contents and/or media content sources consumed and/or preferred by a social network contact of the user of the computing device.

Example 34 includes the computer-implemented method of Example 33, and further includes selectively rendering, by the computing device, the one or more other selectable elements based at least in part on the media contents and/or media content sources consumed and/or preferred by the social network contact.

Example 35 includes the computer-implemented method of any one of Examples 31-34, and further includes selectively rendering, by the computing device, the one or more selectable elements based at least in part on a pattern of media content consumption of a user of the computing device.

Example 36 includes the computer-implemented method of any one of Examples 31-34, wherein the media content is a first piece of media content in a sequence of media contents, and the one or more other media contents comprise a second piece of media content of the sequence.

Example 37 includes the computer-implemented method of any one of Examples 31-34, wherein the selectively rendering comprises selectively rendering, by the computing device, one or more selectable elements that are operable to cause the computing device to present on the display one or more digital photographs and/or video clips pertinent to the media content.

Example 38 includes the computer-implemented method of Example 37, wherein the video clips comprise an interview with a person associated with the media content.

Example 39 includes the computer-implemented method of any one of Examples 31-34, wherein the obtaining comprises obtaining, by the computing device, information about a person or entity associated with the media content.

Example 40 includes the computer-implemented method of any one of Examples 31-34, wherein the obtaining comprises obtaining, by the computing device, commentary about the media content.

Example 41 includes the computer-implemented method of Example 40, and further includes selectively rendering at least a portion of the commentary contemporaneously with the rendering of the one or more selectable elements.

Example 42 includes the computer-implemented method of any one of Examples 31-34, and further includes selectively rendering, by the computing device, one or more additional selectable elements operable to cause the computing device to retrieve, from the remote computing device or another remote computing device, for presentation on the display, other information pertinent to the media content.

Example 43 includes the computer-implemented method of Example 42, wherein the other information pertinent to the media content comprises commentary and/or an interface that is operable to purchase a good or service related to the media content.

Example 44 includes the computer-implemented method of any one of Examples 31-34, and further includes presenting, by the computing device, the contextual information interface to overlay the media content as the media content is actively presented on the display.

Example 45 includes the computer-implemented method of Example 44, and further includes blurring, by the computing device, at least a portion of the media content while the contextual information interface is presented.

Example 46 includes An apparatus comprising: means for displaying a media content; means for obtaining, from a remote computing device contemporaneously with the displaying, information pertinent to the media content and/or a source of the media content; and means for selectively rendering, on the display based on the obtained information, one or more selectable elements that are operable to cause the apparatus to present on the display one or more other media contents pertinent to the media content and/or the source of the media content.

Example 47 includes the apparatus of Example 46, wherein the means for obtaining comprises means for obtaining, from a social network, social network information about a user of the apparatus.

Example 48 includes the apparatus of Example 47, wherein the means for obtaining comprises means for obtaining, from the social network, information about media contents and/or media content sources consumed and/or preferred by a social network contact of the user of the apparatus.

Example 49 includes the apparatus of Example 48, and further includes means for selectively rendering the one or more other selectable elements based at least in part on the media contents and/or media content sources consumed and/or preferred by the social network contact.

Example 50 includes the apparatus of any one of Examples 46-49, and further includes means for selectively rendering the one or more selectable elements based at least in part on a pattern of media content consumption of a user of the apparatus.

Example 5) includes the apparatus of any one of Examples 46-49, wherein the media content is a first piece of media content in a sequence of media contents, and the one or more other media contents comprise a second piece of media content of the sequence.

Example 52 includes the apparatus of any one of Examples 46-49, wherein the means for selectively rendering comprises means for selectively rendering one or more selectable elements that are operable to cause the apparatus to present on the display one or more digital photographs and/or video clips pertinent to the media content.

Example 53 includes the apparatus of Example 52, wherein the video clips comprise an interview with a person associated with the media content.

Example 54 includes the apparatus of any one of Examples 46-49, wherein the means for obtaining comprises means for obtaining information about a person or entity associated with the media content.

Example 55 includes the apparatus of any one of Examples 46-49, wherein the means for obtaining comprises means for obtaining commentary about the media content.

Example 56 includes the apparatus of Example 55, and further includes means for selectively rendering at least a portion of the commentary contemporaneously with the rendering of the one or more selectable elements.

Example 57 includes the apparatus of any one of Examples 46-49, and further includes means for selectively rendering one or more additional selectable elements operable to cause the apparatus to retrieve, from the remote computing device or another remote computing device, for presentation on the display, other information pertinent to the media content.

Example 58 includes the apparatus of Example 57, wherein the other information pertinent to the media content comprises commentary and/or an interface that is operable to purchase a good or service related to the media content.

Example 59 includes the apparatus of any one of Examples 46-49, and further includes means for presenting the contextual information interface to overlay the media content as the media content is actively presented on the display.

Example 60 includes the apparatus of Example 59, and further includesmeans for blurring at least a portion of the media content while the contextual information interface is presented.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. At least one non-transitory computer-readable medium comprising instructions that, in response to execution of the instructions by a computing device, enable the computing device to present a contextual information interface associated with a media content on a display, wherein present the contextual information interface comprises:
obtain, from a remote computing device contemporaneously with the presentation of the contextual information interface, information pertinent to the media content and/or a source of the media content; and
selectively render, based on the obtained information, one or more selectable elements that are operable to cause the computing device to present on the display one or more other media contents pertinent to the media content and/or the source of the media content.

2. The at least one non-transitory computer-readable medium of claim 1, wherein obtain comprises obtain, from a social network, social network information about a user of the computing device.

3. The at least one non-transitory computer-readable medium of claim 2, wherein the social network information comprises information about media contents and/or media content sources consumed and/or preferred by a social network contact of the user of the computing device.

4. The at least one non-transitory computer-readable medium of claim 3, wherein the one or more other media contents are selected based at least in part on the media contents and/or media content sources consumed and/or preferred by the social network contact.

5. The at least one non-transitory computer-readable medium of claim 1, wherein the one or more other media contents are selected based at least in part on a pattern of media content consumption of a user of the computing device.

6. The at least one non-transitory computer-readable medium of claim 1, wherein the media content is a first piece of media content in a sequence of media contents, and the one or more other media contents comprise a second piece of media content of the sequence.

7. The at least one non-transitory computer-readable medium of claim 1, wherein the one or more other media contents comprise one or more digital photographs and/or video clips pertinent to the media content.

8. The at least one non-transitory computer-readable medium of claim 7, wherein the video clips comprise an interview with a person associated with the media content.

9. The at least one non-transitory computer-readable medium of claim 1, wherein the information pertinent to the media content comprises information about a person or entity associated with the media content.

10. The at least one non-transitory computer-readable medium of claim 1, wherein the information pertinent to the media content comprises commentary about the media content.

11. The at least one non-transitory computer-readable medium of claim 10, wherein the present further comprises selectively render at least a portion of the commentary contemporaneously with the render the one or more selectable elements.

12. The at least one non-transitory computer-readable medium of claim 1, wherein the one or more selectable elements are further operable to cause the computing device to retrieve, from the remote computing device or another remote computing device, for presentation on the display, other information pertinent to the media content.

13. The at least one non-transitory computer-readable medium of claim 12, wherein the other information pertinent to the media content comprises commentary and/or an interface that is operable to purchase a good or service related to the media content.

14. The at least one non-transitory computer-readable medium of claim 1, wherein present the contextual information interface further comprises present the contextual information interface to overlay the media content as the media content is actively presented on the display.

15. The at least one non-transitory computer-readable medium of claim 14, further comprising instructions that, in response to execution of the instructions by the computing device, enable the computing device to blur at least a portion of the media content while the contextual information interface is presented.

16. An apparatus comprising:
one or more processors;
memory coupled with the one or more processors; and
a user interface engine coupled with the one or more processors and configured to present a contextual information interface associated with a media content on a display, wherein present the contextual information interface comprises:
obtain, from a remote computing device contemporaneously with the presentation of the contextual information interface, information pertinent to the media content and/or a source of the media content; and
selectively render, based on the obtained information, one or more selectable elements that are operable to cause the apparatus to present on the display one or more other media contents pertinent to the media content and/or the source of the media content.

17. The apparatus of claim 16, wherein the remote computing device is associated with a social network, and the information pertinent to the media content and/or a source of the media content comprises social network information about a user of the apparatus.

18. The apparatus of claim 17, wherein the social network information further comprises information about media contents and/or media content sources consumed and/or preferred by a social network contact of the user of the apparatus.

19. The apparatus of claim 18, wherein the user interface engine is to selectively render the one or more other selectable elements based at least in part on the media contents and/or media content sources consumed and/or preferred by the social network contact.

20. The apparatus of claim 16, wherein the user interface engine is to selectively render the one or more selectable elements based at least in part on a pattern of media content consumption of a user of the apparatus.

21. The apparatus of claim 16, wherein the user interface engine is further to present the contextual information interface to overlay the media content as the media content is actively presented on the display.

22. The apparatus of claim 29, wherein the user interface engine is further to blur at least a portion of the media content while the contextual information interface is presented.

23. A computer-implemented method comprising:
displaying, by a computing device on a display, a media content;
obtaining, by the computing device from a remote computing device contemporaneously with the displaying, information pertinent to the media content and/or a source of the media content; and
selectively rendering, by the computing device on the display based on obtained information, one or more selectable elements that are operable to cause the computing device to present on the display one or more other media contents pertinent to the media content and/or the source of the media content.

24. The computer-implemented method of claim 23, wherein the obtaining comprises obtaining, by the computing device from a social network, social network information about a user of the computing device.

25. The computer-implemented method of claim 24, wherein the obtaining comprises obtaining, by the computing device from the social network, information about media contents and/or media content sources consumed and/or preferred by a social network contact of the user of the computing device.
